(19) United States
(12) Patent Application Publication
(10) Pub. No.: US 2020/0027134 A1
(43) Pub. Date: Jan. 23, 2020

(54) Universal authentication of in-window purchasing and communication of embedded digital advertisement

(71) Applicant: William Henshaw Herling, Gig Harbor, WA (US)

(72) Inventor: William Henshaw Herling, Gig Harbor, WA (US)

(21) Appl. No.: 16/517,478

(22) Filed: Jul. 19, 2019

Related U.S. Application Data
(60) Provisional application No. 62/764,137, filed on Jul. 19, 2018.

(51) Int. Cl. G06Q 30/02; G06Q 30/06

(52) U.S. Cl. CPC G06Q 30/0271; G06Q 30/0641; G06Q 30/0277

(57) ABSTRACT

Method of facilitating engagement with an interactive window embedded within a digital platform is described. The method includes a way to process electronic payment for goods or services within a nested window, embedded within a digital platform or portal, regardless of device type or access point, that enables payment from within an advertisement. Additionally, the method includes a way to engage with an interactive window, through a number of elements, including embedded communication and embedded communication with an automated conversation messenger, or chat bot. The advantage of the present invention is to eliminate the need for an outbounding link to disrupt the experience within a digital publisher, platform, or portal, and instead, create a connected way to share, explore, and purchase products or services through advertisements that are embedded within the platform or portal itself.

### CROSS-REFERENCE TO RELATED APPLICATIONS

This application claims priority to U.S. Provisional Patent Application 62/764137 entitled “Universal authentication of in-window purchasing and communication of embedded digital advertisement” filed Jul. 19, 2018.

### FIELD OF THE INVENTION

The present invention relates to computer-based systems, platforms, and methods to facilitate the engagement of digital advertisements. Specifically, the present invention pertains to reducing outbounding links connected to digital advertisements within the publisher presented experience.

### BACKGROUND OF THE INVENTION

As digital usership significantly increases, across a varied landscape of computer devices and platforms, a likewise increase in the number of digital advertisers, and subsequently the number of advertisements that are shared digitally, will similarly increase. Commonplace today, in a typical digital advertising experience, an advertisement will appear on the platform of a publisher. A digital advertisement that is presented to an end-user, or the person being advertised to, will contain a clickable element that will provide an outbounding link, or a link that will leave the platform of a publisher and redirect the end-user to a new window, or separate heading, that is often the advertiser's own website or purchase point. This experience creates problems for many stakeholders. For a publisher, time spent within a platform is an important measuring marker, as more content that is consumed by an end-user, the better for the publisher. The more an end-user stays on the platform of a publisher, the more content they will theoretically engage with, and the more advertisements they can show as well as more value they bring to the end-user. The more value they bring, the more the end-user comes to the publisher. Similarly for the advertiser, a new window experience is often seen as a significant impediment to the experience, as the URL outbounding link needs to load, which can take a significant amount of time, and the experience overall can seem disenchanting to the end-user. For the end-user, the advertisements that route to an outbounding link often creates a long, disrupting experience that misplaces the original intent and removes the end-user from the platform where the advertisement originated to them. Disrupting with this experience often increase the loss of the end-user, as the end-user will disengage. This happens across different sites and platforms, both mobile and not, that significantly disrupt the platform, portal, or publisher experience for the end-user, an experience the publisher goes to great lengths to design and maintain for the enjoyment of the end-user. Platforms, portals, and publishers often use advertising as a significant source of revenue, and as such, heavily rely on digitally displayed advertisements to maintain or march to profitability, which has performed with muted pressures. Thus, an opportunity exists to create a method that reliably keeps an end-user within the platform of a publisher, where an experienced is designed for them, that enables engagement with advertisements across separate publishers, to track, record, and process engagement unique to the end-user, through advertisements embedded within each publisher platform respectively.

BRIEF SUMMARY OF THE INVENTION

In general, the present invention provides a way to engage with an advertisement and the elements it embodies, including purchasing, exploration, and messaging, within an embeddable digital advertising component, without leaving the platform, portal, or site by which the advertisement is presented. The benefit of this invention is the ability for an end-user to remain within a platform, portal, or publisher site while engaging with the actionable embodiments of an advertisement. In this way, a publisher gains significant benefits as an end-user remains within their platform or portal, while likewise, an end-user gains significant benefits with a better experience designed to avoid outbounding links, which are predominantly commonplace in contemporary digital advertising. Additionally, the end-user sees added benefits with a universal authentication protocol which tracks, stores, processes, and analyzes information specific to each end-user across each unique embeddable digital advertising component across varied platforms or portals. The benefit of this behavior of the present invention, offers a way for an end-user to move from site-to-site, within a session, and have a common shared ‘cart’ with products, preferences, financial information, or message communications, enabled through a universal authentication protocol and unified backend server processing system. The embeddable digital advertising component acts independently of the platform, portal, or site, by which it is integrated on. This independence is significant in the ability of the embeddable component to maintain up-to-date information regarding an end-user, with the flexibility to dynamically adapt in real time, to newly improved advancements through third-party innovations. The method, utilizing a shared backend server system, that communicates information and receives inputs in real time, across a number of platforms or portals, offers embeddable and interactive components. In-window payment, is way for an end-user to purchase a product or service via an embeddable digital advertising component, while remaining fully within a platform or portal where the advertisement was presented. By way of example, an end-user may purchase a product via an embeddable advertisement within Platform A, without leaving Platform A. Communication embodiments are also represented within the embodiment of the invention, specifically a way to message within an advertisement through a shared backend system, communicating with other, separate and distinct embeddable digital advertising components on other platforms, or through a pragmatic communication system, or chat bot, or through an individual representing the organization advertising.

### BRIEF DESCRIPTION OF THE DRAWINGS

FIG. 1 illustrates the relationship connectivity between the embedded digital element and the floating backend server by which it aggregates, collects, and then processes information. The figure highlights the activity that occurs as the end-user or authenticatee engages with the embedded digital advertising element within a digital platform or portal. At numeral 100, the process begins where an end-user or authenticatee is presented with an embedded digital advertising component, where they are pinged to universally authenticate their identity. This embedded digital advertising component is nested within a digital platform, application, website, browser, or other portal, and behaviors are enabled within the nested view, while correspond to the virtual floating backed as described. The universal authentication protocol occurs at numeral 110, which validates the identity of the end-user or authenticatee at numeral 115 by connecting to the shared data backend, noted at numeral 160, which will continue to play an on-going role in the facilitation and authentication of shared input behaviors of an end-user or authenticatee. If the end-user or authenticatee is authenticated, and the task is confirmed, at numeral 110, it is then facilitated during that session as authenticating the end-user or authenticatee on all future platforms or portals within the current session, as designated by numeral 110. Numeral 110 illustrates all successive platforms or portals that a user may access during a shared session, or the amount of time or behavioral duration a user is in a distinct location, distinct wifi or network connection, on a platform and or browser, or on a shared period of engagement. If a user is not authenticated, the process repeats until an end-user or authenticatee is authenticated. Once authenticated, the end-user or authenticatee can perform an action, as noted in numeral 120, where several different engagement elements, now known or later developed, that enables an end-user or authenticatee to engage with the embedded window. By way of example, an interaction may be engaging in clickable segments that produce new information, utilizing a conversation or chat bot, or engaging with an interactive social element. This is illustrated by a two-way arrow that is connected to numeral 130 which process the outcomes of the engagements through the embedded digital advertising window, that sits embedded within a platform or portal, and processes aggregated data from numeral 160. Numeral 130 takes the input variables from numeral 120, processed and aggregated in real time, and combines this data with the floating backend system, as noted in numeral 160, which together process the inputs to perform relevant outputs at numerals 135, 140, and 145. These outputs may be, but are not limited to, payment processing, communication within embedded digital advertising components on other platforms or portals, or with a pre-programmed automated advertising bot, or other end outcome, such as a reward variable. The inputs are stored, analyzed and processed via the floating backed system as depicted in numeral 160, which optionally processes data from third-parties, noted at numerals 170 and 175. Numeral 175 represents the third parties, while numeral 170 indicates the ability optionally process the information shared by the third party or parties, to enhance performance, processing efficiencies, or enhanced engagement opportunities. Engagement opportunities, by way of example, may be a reward based platform that integrates and stores cross functionally with the backend processing system noted in numeral 160, which is processed within the embedded digital advertisement at numeral 130. Those outputs, aggregating at separate points in real time, are then processed and displayed within the embedded digital advertising component, or components if cross functionally shared, at numeral 150. That information is then shared, stored, analyzed and processed at numeral 160, which will share, aggregate, and take into account this information in future engagements.

FIG. 2 depicts the ability of the method to track an individual user between portals, regardless of platform type, computer type, or how the embedded digital advertisement component was accessed. This method enables the ability for the floating backend system to track a specific authenticatee across websites, apps, platforms, and portals regardless of access point or device type. This method further enables interactive elements from within the embedded digital advertisements to be custom and unique to the authenticatee. At numeral 200, the embedded digital advertisement is engaged with by an end-user or authenticatee, that sits within a platform or portal that operates independently of it, but is nested within it. When a end-user or authenticatee engages, it communicates the activities, at numeral 210, and thereafter analyzes, stores, and process with the shared floating backend system this information. This information is used to facilitate the embodiments of the present invention that increase relevance, enhance communication, or increase engagement opportunities with the end-user or authenticatee through the embedded digital advertising component. The backend server system, that is agile in nature, flexibly connects to other connectivity points and embedded digital advertising windows across separate platforms, portals, devices, and other engagement embodiments with the ability to work with other third party services and storage mechanisms, as defined in FIG. 1. This cross platform and agnostic type capability is highlighted in numeral 220. Numeral 220 contains the emobidements of connectivity and intermodal hybridity that offers the functional capabilities as described in FIG. 1. Numeral 220 further connects with different platforms and device types as represented with numeral 230, numeral 235, and numeral 240. These elements can communicate together and display, within session parameters and access parameters, as indicated by numeral 250. The multiple arrow endpoints on numeral 250, represent the ability to share information through the embedded digital advertising component window, across multiple platforms and access types simultaneously, overriding previous display information if an end-user or authenticatee were to return to a previous platform or portal, within the defined session period and parameters. This illustrates principally the ability to track a user through shared endpoints, via the floating backend server system, that enables the ability to track an end-user or authenticatee across platform or portal, regardless of device type, access point, or feature, and share, aggregate, analyze, process, and display information across embedded window embodiments in real time.

FIG. 3 represents the ability to track multiple authenticatees at any one time. The figure reflects distinct, separate endpoints with a shared common backend system that enables the effect of the behavior of the invention to facilitate its core functionality across different platforms or portals, regardless of device type, access type, or platform requirement. At numeral 300 information is shared to different and distinct platforms, portals, device types, and access points. The information transferred and processed prior is then displayed within the platform or portal, adapting to the in-window embodiment requirement of the described method, as represented by numeral 310, numeral 315, and numeral 320 that are illustrated in different sizes, characteristics, and embodiments. Double arrows reflect the multi faceted sharing of information, both directions, that continue to enhance the end result to drive better engagement of the end-user or authenticatee. In this way, information can be shared to multiple end-users or authenticatees within the same platform or portal, but with different session parameters, unique to the individual end-user or authenticatee. By allowing information to disseminate to multiple different end-user or authenticatees at the same time, information can be shared at scale in real time, helping the originator of the advertising content. This information is shared and gathered by multiple end-users or authenticatees at one time. In this way, an advertiser may share content out to multiple different end-users or authenticatees who have very distinct and separate inputs, interactions, engagements, or like behaviors. The separate sizes, depicted with the dashed border lines, represent multiple separate end-user or authenticatees within the same portal or platform, as shown with numeral 315 and numeral 320. Likewise, numeral 310 represents a single end-user or authenticatee on one platform or portal, which can still send and receive pertinent information to increase the effectiveness of the digital advertising content, embedded within the platform or portal displayed as a window to the end-user or authenticatee.

### DETAILED DESCRIPTION OF THE INVENTION

Described is a method of purchasing and engaging with a product or service directly within an embedded advertisement window. Today, as described earlier, an individual using a website, mobile application or other digital platform, goes through great lengths to purchase items or services digitally. Often, when desiring to learn more about a product or service via a digital advertisement, an individual will be redirected to a separate site or platform to learn more or complete a purchase. This redirection of an individual to a separate portal is undesirable for the original portal host or publisher of where the advertisement is being displayed to an end-user, as maximizing time spent on their portal or application is desired, and redirection to a separate portal or link limits this factor considerably. Additionally, advertisers aim to become less budrendsome in the experience they offer a potential customer, or end-user. The current process that is heavily reliant upon images is grossly ineffective to this objective, and considerably limits the scope by which a publisher or platform intends to better design an experience for an end-user.

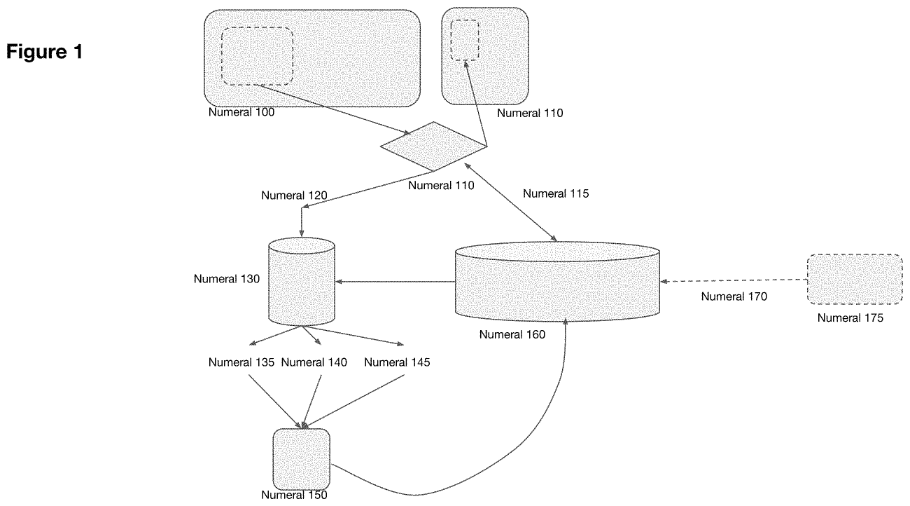

Thus, the advantage of the method is to offer a self-contained, embeddable purchase window that creates a way for an individual or end-user to purchase an item or engage directly with an advertisement to learn more about it, without ever leaving the original application or portal where the advertisement was originally presented to them. The alignment of this method fits to benefit the original portal host, publisher or platform, for the purposes of this description, as time is spent on the original host or publisher platform while allowing flexible, component based advertisements to still be served from a third-party, benefiting the end viewer of the advertisement, as a third-party advertisement unit may offer more advanced targeting or relevant behavioral understanding of the individual. The third-party integrations which are represented by numeral 170 and numeral 175 in FIG. 1, highlight the importance that third-party advertisement tracking to aid in optimization, third-party data to enhance creative specialized unique to an end-user, third-party interactive or enhancing elements, and other third-party data sets that are used, in an optional capacity, to increase the relevance, engagement, or targeting to an end-user. This is significantly important to the advertiser as these tools, designed within the embodiment of the invention, to integrate in a flexible and dynamic way to better yield optimal results of the advertiser and publisher, alike.

The embedded advertisement may sit directly on the application or platform via a backend server, operating as a plugin or third-party embeddable mechanism. This embeddable digital component, increases the likelihood a user can stay engaged on a platform or portal, without being re-routed via an outbounding link to a separate window. By being embedded within the platform or portal where the advertisement originates its presentation to an end-user, the experience is significantly changed to better keep an end-user within a platform or portal, where an experience has been designed for them. The embeddable nature of the present invention solidifies the experience, acting in an independent way from the surrounding content blocks, elements or other captive items within the platform or portal. By operating independently, third-parties and unique information pertinent and specific to the end-user can be fulfilled, acting in a more unified manner across platforms, portals, publishers and other means, regardless of device type, access point, or other initiation factor. Thus, the embodiment of the present invention is fully embeddable within a platform or portal, regardless of device type or access point, yet acts independently from the platform or portal itself and the content it represents. Security features and moderation features are important components of this method. The authentication of the end-user profile works with the embeddable component to authenticate the identity of the individual, that works additionally in compatibility with the affiliate or tracking element uniquely identifying the end-user. A tracking mechanism may include an extension, including a filtering and blocking extension such as an ad blocker, that filters advertising content to a personalized level, authorized via proper authentication protocols. Additionally the information of an individual may be stored offline using an application, or via an online tracking component, such as cookies. The method can also follow component based advertising to alter the shape and presentation of the digital advertisements to match the design of the platform, portal, or site sharing the advertisement, as it does so independently through a third-party integration embodiment, as shown in FIG. 1. Highlighted in this scenario, the authentication portal and tracking displays sit on top of or overlay the design of the advertising and design components.

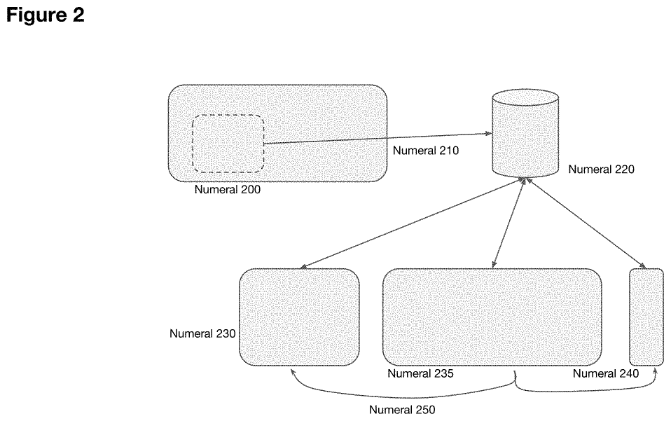

The authentication protocol also offers unique elements to this method, specifically the ability to store shared information unique to each individual across separate and distinct platforms. Separate and distinct platforms are websites, application or portals that are unique from each other, operated as separate bodies, often unaffiliated with each other. This universal authentication protocol offers a way for an individual to directly access a unique profile across platforms, as this profile grants authentication access to information unique to that individual, that may store unique and sensitive payment information, coupons or rewards, and general gamification elements. This is illustrated in FIG. 1, particularly numeral 160, and in FIG. 2, which depict the method by which an individual can be followed, within session, across different platforms, portals, and devices. For the purposes of a description of the invention, a session, or shared or consistent session, is a module by which an end-user is recognized consistently for a measurable duration, which enables the authentication protocol described in FIG. 1 to support an end-user moving from site-to-site, or between platforms, to remain authenticated, and thereby gain recognition of their identity continuously, gaining the interactive benefits and sharing of continuous adaption of information. A session can be measured by a shared location, enabling a secure wifi router for an end-user to rely on to move between a mobile phone and a desktop, or through a consistent browser, or through a ‘logged in’ mode, where a user self-identifies, or through another measurable session parameter. By way of example this allows an individual or end-user to ‘save’ an item through an advertisement seen embedded on Platform A, and able to reaccess that item on Platform B, and even add new material through Platform B, in a shared checkout ‘cart’ or bundling of content into one unified place, which uses a session to measure the continuous authentication. In this scenario, an embeddable advertisement displayed on a website may intrigue an individual, so much so that they wish to make a digital purchase of the advertised item. To do so, the individual would authenticate as described in verified methods above, and be able to purchase the item directly from within the advertisement, never leaving the original site or portal. Comparatively, in a traditional model, the individual would select the advertisement, and be redirected to a new window or website, where they could explore the product or purchase the product. The individual would then need to return to the original site that delivered the advertisement to resume their experience there.

This illustrates the opportunity of reward based incentives that move from site to site, visible through embeddable advertisements or a singular platform, that are accessed via the universal authentication, principally using third-party infrastructure as shown in FIG. 1, numeral 170 and 175. The reward currency, allows discounts or other incentives through the shared network delivered to the end-user or authenticatee. These rewards, as with other elements, are accessible across platform, portal, and publisher regardless of content type, device type, or access point. This enables an independent, embeddable component to engage with multiple applications, including third-party sources, to aggregate relevant information shared and displayed to the end-user within a specific embedded window. This method creates a universal authentication protocol, that authorizes all advertisements displayed within approved affiliate networks, unique to host servers, or through a deliverable mechanism (such as a plugin), to deliver targeted advertisements that sit uniquely on a site and offer a shared payment, reward, and exploration system, unique from authenticatee to authenticatee across platforms within a shared session. Likewise, this operation creates a way for an individual to build a shared cart, visible through the embeddable window, to operate functionally from site to site uniquely to that site. To create a way for an individual to create a shared cart, connected from platform to platform, separate and independent of each other, visible through the embeddable window, to operate functionally as a common checkout portal. By way of example, an individual could add a product or service on one site, and add a second product to the same cart on a separate site, and check out, utilizing a payment process, for both products on that site. Through this way, the individual can avoid two separate checkouts and two separate outbound sessions away from their original host of where the advertisement originated. Other gamification components including ‘liking’, favoriting and sharing advertisements, dependent on the unique profile of the individual.

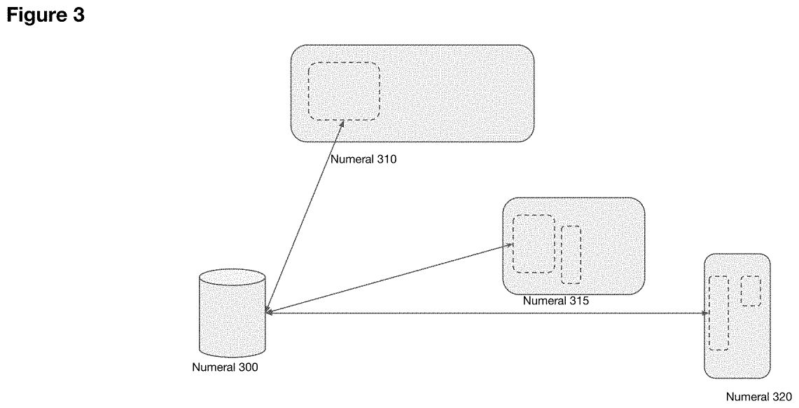

Payment processing is enabled within the embeddable digital advertising component that offers a way for an individual to purchase goods or services, through advertisements independently stored on a platform or site. In this method, payment information is stored unique to a user, as well as the items to be purchased are stored in a way unique to each user, through functionality utilizing the authorized protocol. As illustrated in FIG. 2, shared information will follow an end-user through a shared session, which enables a period of measured involvement to be ‘signed-in’ to the independent connectivity of embeddable digital advertising components, as shown in FIG. 3. This shared information includes financial security features and other third-party elements to protect the privacy of the end-user between platforms or portals. Because the embeddable digital advertising components are independent, and acting as an element independent of the platform or portal by which it sits, as an independent embeddable element, much of the financial processing occurs through this shared backend system.

Additionally, a method for a direct communication within an advertisement exists to tie directly to the universal authentication system. This method illustrates a way for an individual to message an advertisement directly, operating either through a live communication or pre-build messaging application or, as it is more commonly known, a chat bot. By tying directly to the universal authentication protocol, the messages may be more tailored to each individual. This communication and messaging is enabled through the method illustrated in FIG. 1, where an embodiment represents the ability to authenticate an end-user and connect that end-user to a messaging system, either connecting with other embeddable components, like comments, or through a pre-built messaging application. By having this embedded directly with the advertisement, the individual does not need to leave the original portal by which the advertisement was initially presented, thus benefiting this portal host. By way of example, an end-user may have a question about a product, shared with them through the embeddable advertising component, in-window. In this example, the end-user may message the advertisement directly, finding answers to their questions through an automated messaging system, a customer service representative, or through another user via the embeddable advertising component. Communicating directly with a shared backend system, the universal authentication protocol may access stored profile and information database, identifiable by a verified form of authentication that is unique the authenticatee or individual, this is in part, illustrated in FIG. 3 which achieves a better communication outcome, acting independently via an embeddable advertising component, through a better publisher, platform, and portal experience for the end-user receiving a digital advertisement.

What is claimed:

1. A method for interacting with a digital advertising component embedded within a fixed digital platform, comprising:
existing alongside the content on the platform or display portal, that itself, exists in a distinct, separate, and independent way of the embedded digital advertising component;
installing in a manner that is embedded within a platform or display portal integrated across different platforms, device types, and integration channels;
communicating with third party services, to unify and enhance the component in terms of direct targeting capabilities to an end-user that increases the relevance of the advertising component to a unique authenticatee and to better augment storage and process of performance data to impact future behaviors of the component;
sharing a floating backend server system to process with the capability to connect to other embedded windows, across platform and device type, agnostically, in real time, to enable a gathered grouping checkout process;
authorizing unique identifiers via authentication protocols to enable customization across platform and device type; and
responding to the interactive inputs of an authenticatee through the use of a number of input interaction methods.

2. Method of claim 1, wherein a digital component, that is fully embedded within a platform or group of platforms, is able to correspond and communicate with a backend server system, that is unique and agile in nature to each end-user or authenticatee, to facilitate cross platform sharing and gathering of information.

3. Method of claim 1, wherein an individual can authenticate universally, via a floating backend system, that once authorized, enables communication within session, across platform or access type.

4. Method of claim 1, wherein an embedded digital advertising component can share and receive information from a backend server system to modify its presentation and engagement to an authenticatee based on the processed information.

5. Method of claim 1, wherein an authenticatee can interact with a number of engamment features, ranging in varied scope and functionality, directly within the embedded digital advertising component, avoiding outbounding movement.

6. Method of claim 1, wherein the system recognizes the inputs and actions of the authenticatee to recognize, process, and adapt the components within the embedded digital advertising component and send to the floating backend system for storage to enhance capability, within session, and for future sessions.

7. Method of claim 1, wherein the system can share information among other embedded digital advertising windows, across separate platform and access type, in real time.

8. A computer product for an authenticated digital user to purchase and engage with a payment processing system to purchase or execute the payment for goods or services through within an embedded digital advertisements, comprising:
remaining within a platform or shared portal, without performing an outbounding action, resulting in the end-user or authenticatee remaining on the original platform or portal;
cataloging and sharing unique user information that can identify with accuracy the end-user or authenticatee and any information that may possess, via a backend server system, critical to the execution of the payment for goods or services;
communicating with third-party services in an effort to maintain security and functional efficiency in the payment processing of financial information to execute the payment for goods or services within the embedded digital component; and
securing personal information of end-user or authenticatee through standardized security protocols, tools, and third-party services to ensure the safety of sensitive financial information unique to an end-user or authenticatee.

9. The method of claim 8, wherein an individual end-user or authenticatee, after performing an action that identified and universally authenticated their identity, through the protocol of the method defined, can share information across separate and distinct platforms or portals through separate embeddable digital components, via a shared floating backend server system, to create a shared grouping or gathering of content, that together comprises a shared cart that can facilitate mass purchasing from goods or services obtained through separate embedded digital components.

10. A computer product to communicate within an embedded digital component to a separate embedded digital component in real time, comprising:
responding to actions inputted through embedded components, parts, or elements that create messaging or corresponding behaviors;
sharing information through a database or floating backend server system that is unique to the end-user or authenticatee; and
corresponding to inputs across separate embedded digital advertising components that are presented to a plurality of end-users displayed in those separate embedded digital advertising components in the form of a conversation element, in real time.

11. The method of claim 10, wherein an individual end-user or authenticatee, after performing an action can communicate with an automated conversation tool, or chat bot, in real time across separate and distinct embedded digital advertising components.
